(19) United States
(12) Patent Application Publication
(10) Pub. No.: US 2012/0018454 A1
(43) Pub. Date: Jan. 26, 2012

(54) ROTARY METERING DEVICE AND SYSTEM

(76) Inventors: Laurence Richard Penn, Leicestershire (GB); Thomas Kevin Milo, Cuyahoga Falls, OH (US); Rodney Ralph Brooks, Lancashire (GB); David Donald Breimeier, Broadview Heights, OH (US)

(21) Appl. No.: 13/130,136

(22) PCT Filed: Nov. 20, 2009
(86) PCT No.: PCT/GB2009/051584

§ 371 Date: Oct. 6, 2011

(30) Foreign Application Priority Data
Nov. 21, 2008 (GB) 0821310.0

(51) Int. Cl. G01F 11/00

(52) U.S. Cl. 222/219

(57) ABSTRACT

A modular rotary metering unit comprising: a housing having at least one liquid inlet and liquid outlet; a rotatable member arranged to rotate about a longitudinal axis thereof with respect to the housing; and at least one bore passing through the rotatable member, the or each bore having two opposing ends and a shuttle element received therein, the shuttle element being movable between two terminal positions, each towards a respective end of the bore, wherein, when the rotatable member rotates, each bore moves in communication with a liquid inlet of the housing and a liquid outlet of the housing such that liquid can be received from the liquid inlet by the bore at the one end of the bore and the shuttle element can eject liquid from the other end of the bore to the liquid outlet, wherein respective first and second engagement elements are provided at first and second ends of the unit, each of the engagement elements being rotationally linked to the rotatable member. Also disclosed is a rotary metering device comprising: a housing having at least one liquid inlet and liquid outlet; a rotatable member arranged to rotate about a longitudinal axis thereof with respect to the housing; and first and second bores passing through the rotatable member, each bore having a two opposing ends and a shuttle element received therein, the shuttle element being movable between two terminal positions, each towards a respective end of the bore, wherein, when the rotatable member rotates, each bore moves into communication with a liquid inlet of the housing and a liquid outlet of the housing such that liquid can be received from the liquid inlet by the bore at the one end of the bore and the shuttle element can eject liquid from the other end of the bore to the liquid outlet.

### DESCRIPTION OF INVENTION

THIS INVENTION relates to a metering device and system, and in particular concerns a rotary metering device.

It has previously been proposed to provide metering devices that operate to dispense precisely measured quantities of liquid. Several different designs of metering device have been proposed.

U.S. 2008/0237257 discloses a rotating shaft having a plurality of bores passing therethrough, at right angles to the longitudinal axis of the shaft. A shuttle is slidably received in each bore, which blocks the bore and is able to move back and forth within the bore between respective terminal positions at the ends of the bore. The shaft is arranged to fit closely within a housing which has, for each bore, external inlet and outlet ports located on opposite sides of the housing, with pressurised liquid being introduced into the inlet port. As the shaft rotates, each bore becomes aligned with the inlet and outlet ports, and the shuttle is driven along the length of the bore, towards the outlet port, by the pressure of the liquid. As it does so, a quantity of liquid is pushed out of the bore by the action of the shuttle, and is ejected through the outlet port. The volume of this ejected quantity is known, and so if the number of rotations of the shaft is known, the total volume of dispensed liquid can be determined.

It is an object of the present invention to provide an improved device of this type.

Accordingly, one aspect of the present invention provides a metering device or unit according to the independent claims.

Optional or preferable features of the metering device or unit are set out in the dependent claims.

In order that the present invention may be more readily understood embodiments thereof will now be described, by way of example, with reference to the accompanying drawings, in which:

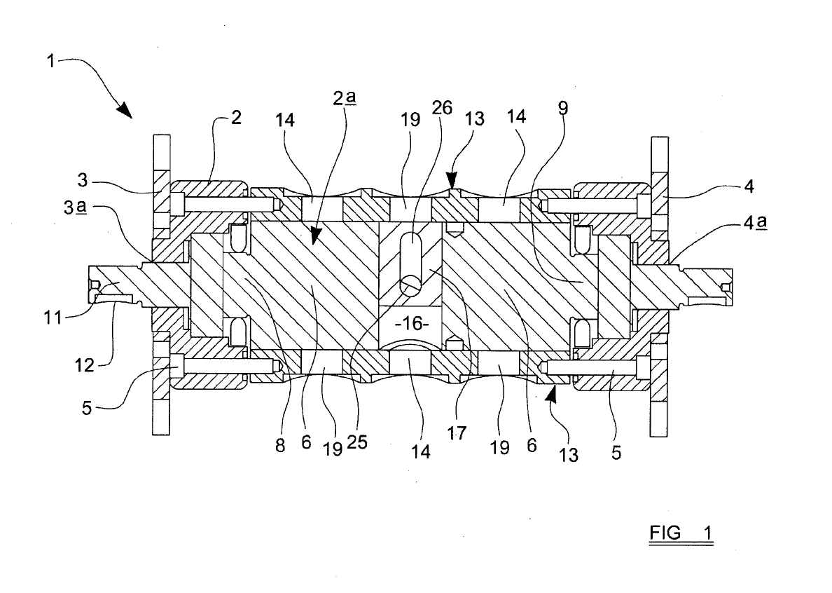

FIG. 1 shows a cross-sectional view of a metering device embodying the present invention;

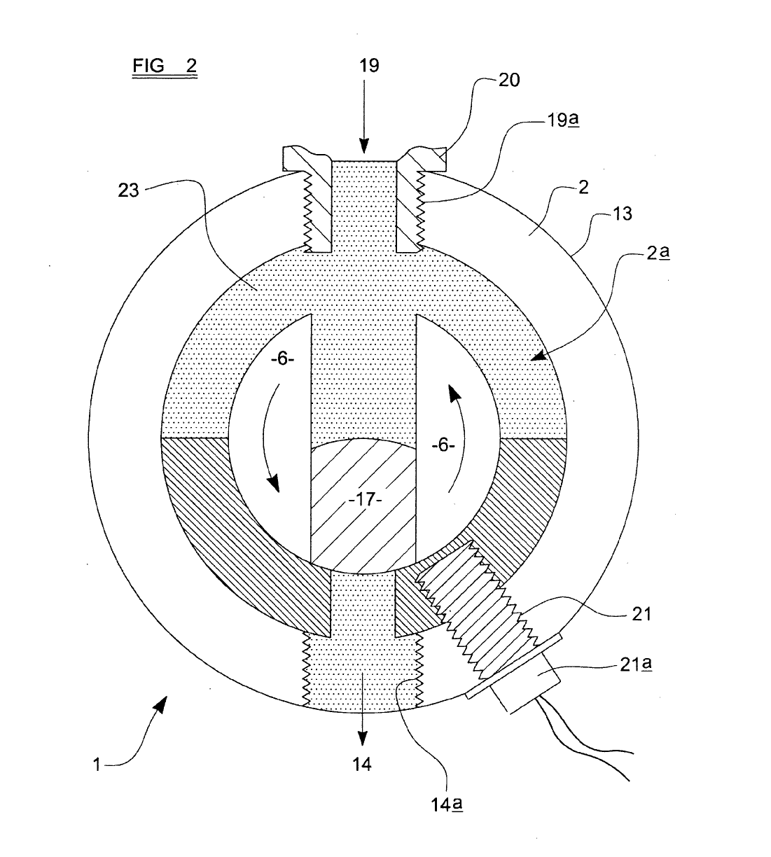

FIG. 2 shows a cross-sectional view of a metering device embodying the present invention; and

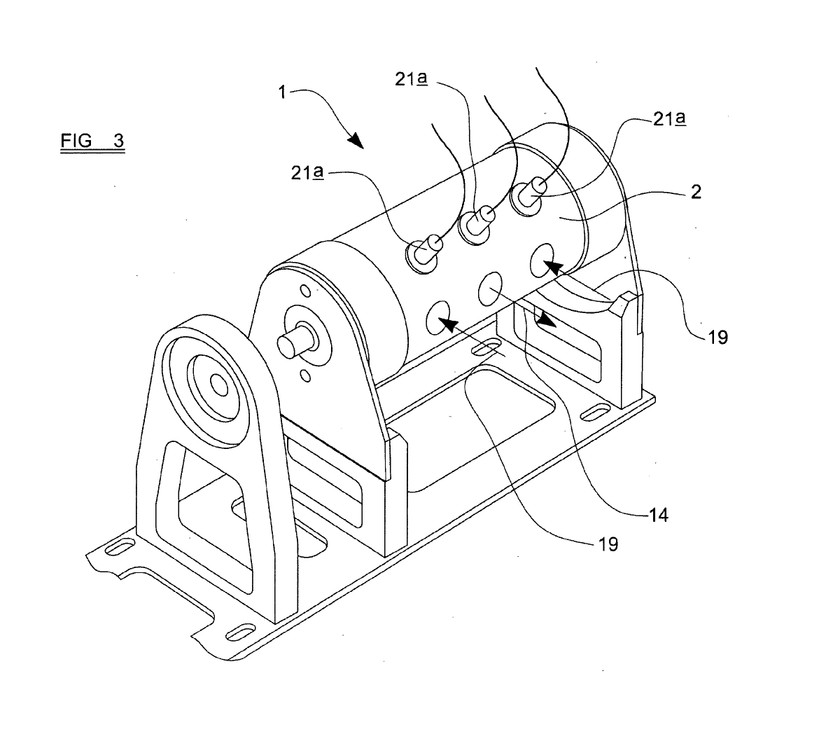

FIG. 3 shows a perspective view of the metering device embodying the present invention;

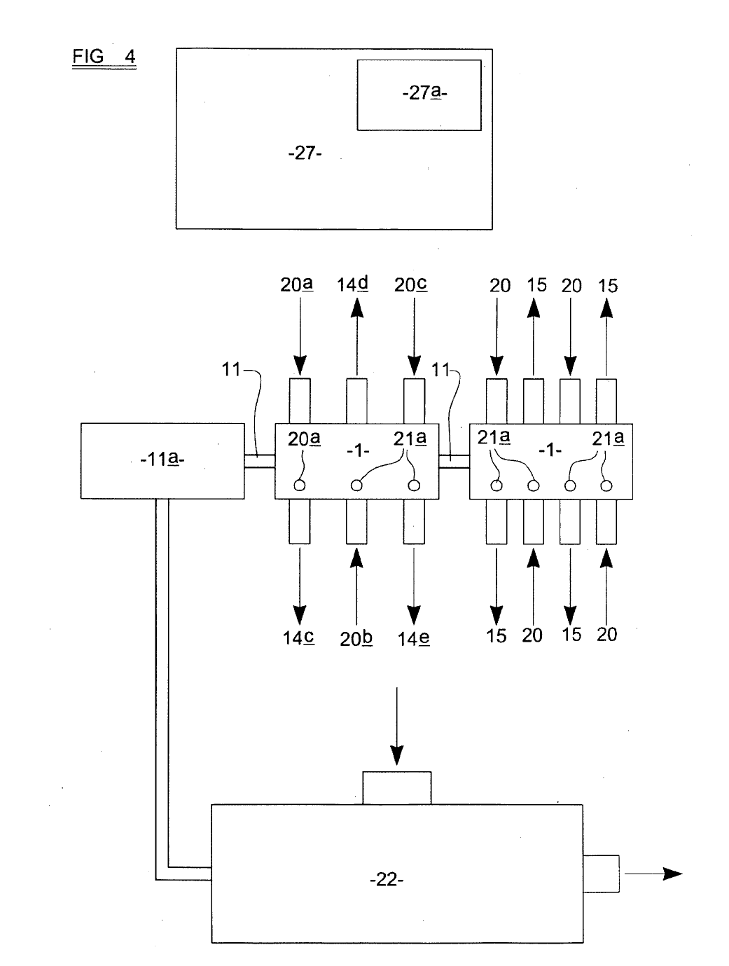

FIG. 4 shows a metering system embodying the present invention;

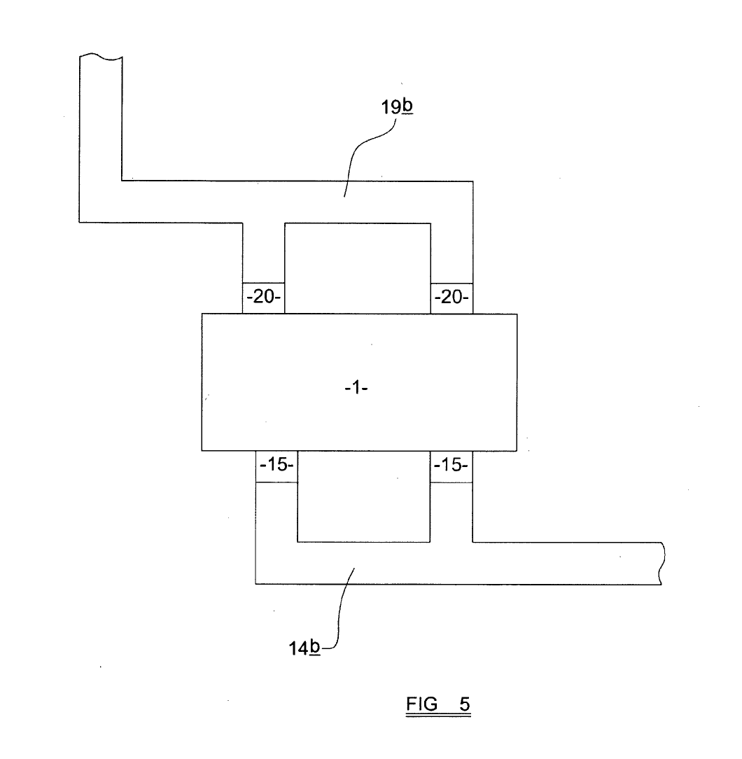

FIG. 5 shows a metering device embodying the present invention;

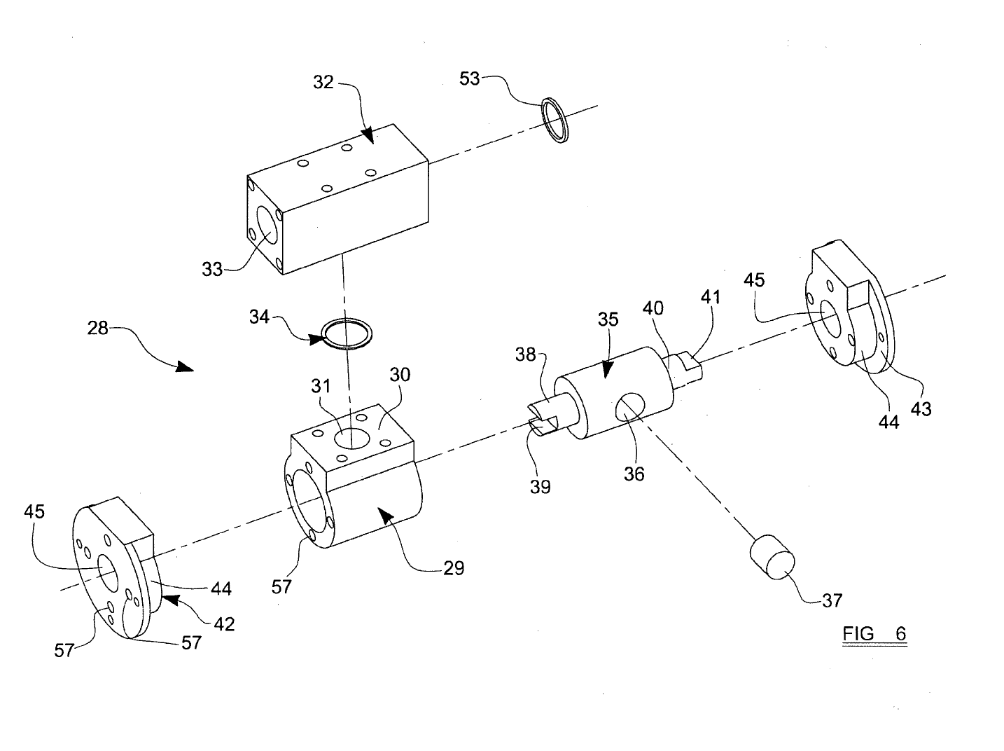

FIG. 6 shows an exploded view of components of a metering unit embodying the present invention;

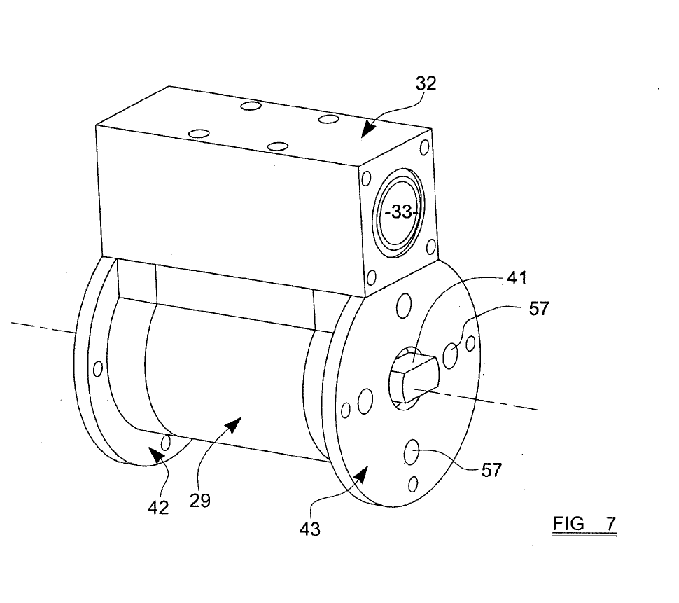

FIG. 7 shows the metering unit of FIG. 6 when assembled;

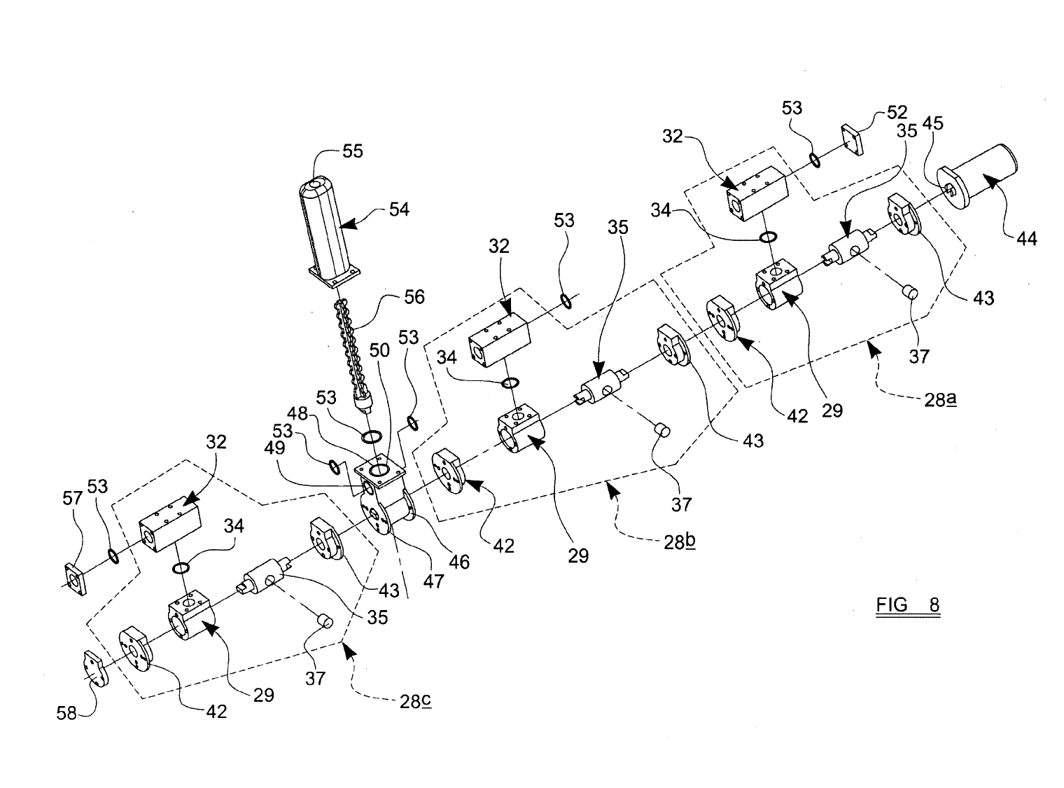

FIG. 8 show an exploded view of components of a metering device comprising a plurality of metering units and a mixing unit;

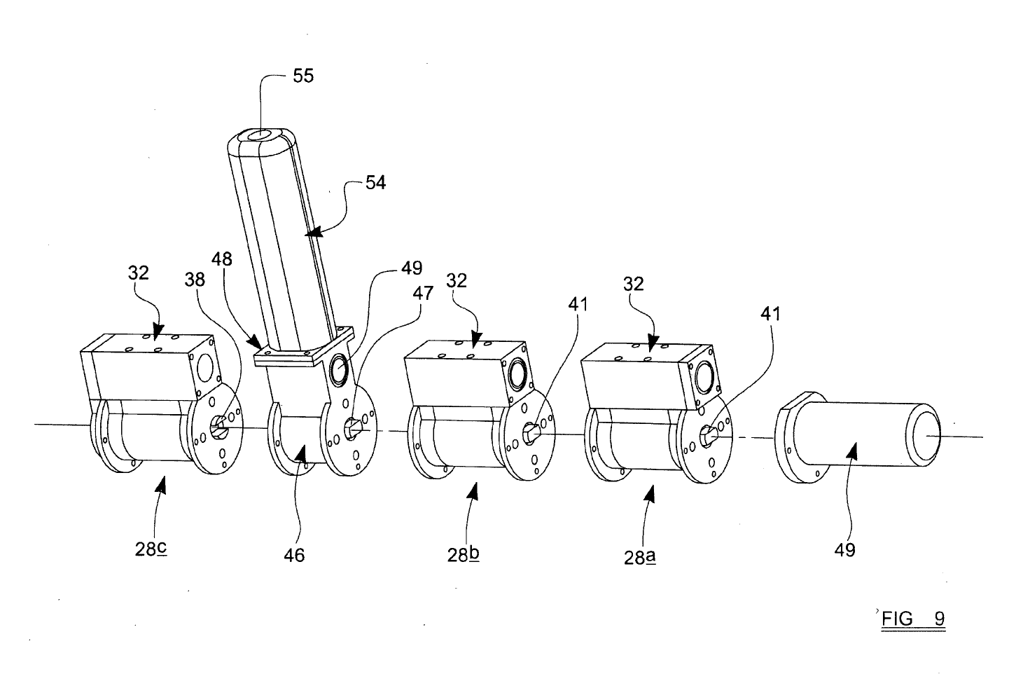

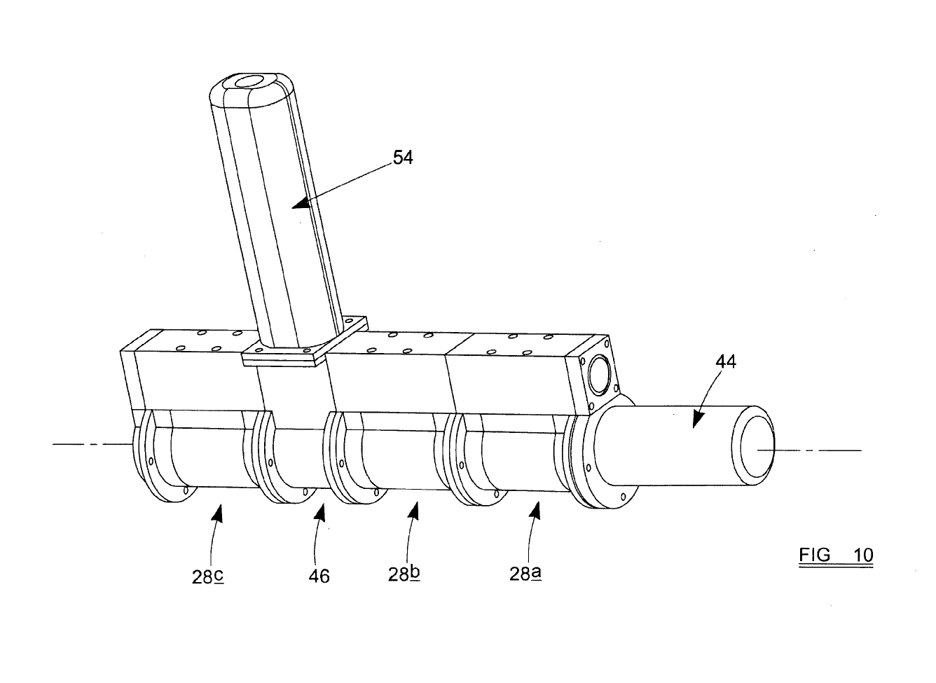

FIGS. 9 and 10 show the components of FIG. 8 in assembled forms; and

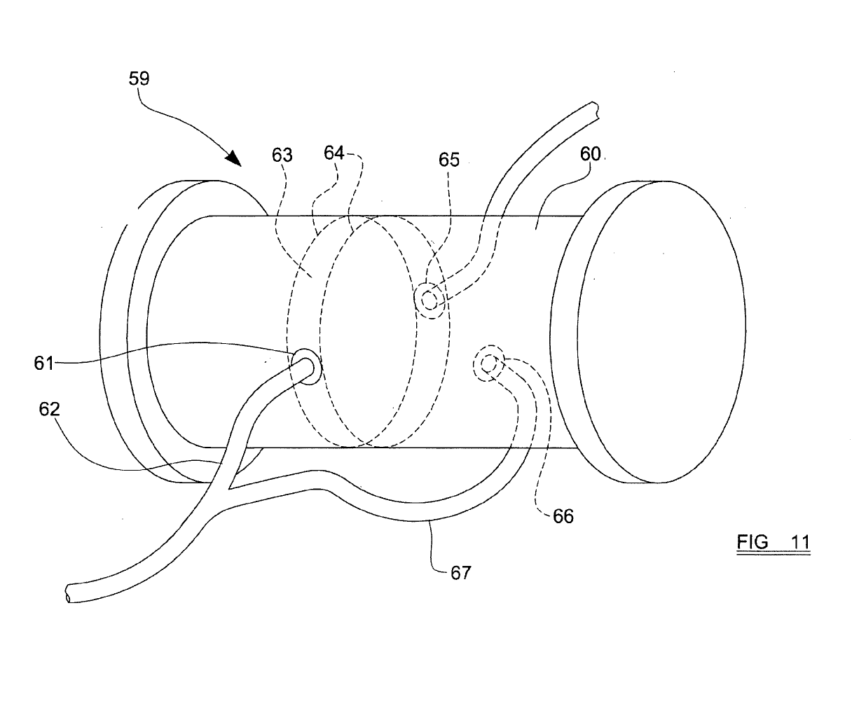

FIG. 11 shows a further metering device embodying the present invention.

Turning firstly to FIGS. 1, 2 and 3, a metering device 1 comprises a housing 2 having a substantially cylindrical internal bore or cavity 2a and open ends which are sealed by first 3 and second 4 end caps which are secured to the housing 2 by means of elongate bolts 5 (or securing screws or a similar securing arrangement).

An elongate rotatable member (or rotor shaft) 6, having a substantially circular cross-section which is smaller than an inner cross-section of the substantially cylindrical internal bore 2a of the housing 2, is received within the housing 2 and is substantially coaxial therewith. A first end 8 of the rotatable member 6 protrudes through an aperture 3a in the first end cap 3, and a second end 9 of the rotatable member 6 protrudes through an aperture 4a in the second end cap 4. The rotatable member 6 is received by bearing surfaces where it meets the first and second end caps 3, 4 and may therefore rotate freely about its longitudinal axis with respect to the housing 2. The apertures 3a, 4a in the first and second end caps 3, 4 may be hermetically sealed around the rotatable member 6 so that the internal bore 2a of the housing 2 is isolated from the surroundings of the housing 2.

A drive shaft 11 protrudes from the first end 8 of the rotatable member 6, and is coaxial therewith. The drive shaft 11 has a substantially circular cross-section and includes a keyed section 12 (preferably a groove or hole) on its outer surface—i.e. a keyway. The drive shaft 11 may be coupled to a motor 11a (shown in FIG. 4) to drive rotation of the shaft 11. The motor 11a may be fitted to the drive shaft 11 such that a keyed section (not shown) of a drive member (not shown) of the motor 11a cooperates with the keyed section 12 of the drive shaft 11 such that rotation of the drive member causes rotation of the drive shaft 11. The drive member of the motor 11a may be part of a belt drive system or a gearbox or may be part of a direct drive system. A drive shaft 11 may also protrude from the second end 9 of the rotatable member 6 in a similar manner (as shown in FIG. 1).

A plurality of inlets 19 is formed in an outer surface 13 of the housing 2. Each inlet 19 may be configured to receive an ingress valve 20 (see FIG. 5) to control the flow of liquid through that inlet 19. The ingress valve 20 is preferably a check valve. Similarly, a plurality of outlets 14 is formed in an outer surface 13 of the housing 2.

Each outlet 14 may be configured to receive an egress valve 15 (see FIG. 4) to control the flow of liquid through that outlet 14. Preferably, however, there is no egress valve 15 and the outlet 14 is connected directly to a liquid outlet pipe 14b (see FIG. 5).

Each inlet 19 is substantially aligned with an outlet 14 across a diameter of the housing 2 (to form an inlet-outlet pair). The inlets 19 and outlets 14 may be of different sizes and shapes but preferably have a circular cross-section and an internal thread 14a, 19a (see FIG. 2).

Each inlet 19 may be evenly spaced along the length of the housing 2—in other words, the inlets 19 may have an equal spacing along the length of the housing 2. The inlets 19 may be arranged in a linear arrangement down the length of the housing 2 or may be staggered around the housing (each inlet 19 being offset at an angular displacement from the or each adjacent inlet 19). Each outlet 14 is arranged so as to be opposite a respective inlet 19 across a diameter of the housing 2.

A plurality of sensor ports 21 (see FIG. 2) is formed in an outer surface 13 of the housing 2. The sensor ports 21 are not aligned with the inlet 19 or outlet 14 ports but are preferably offset at an angular displacement therefrom about the longitudinal axis of the housing 2. In an embodiment, each pair of inlet 19 and outlet 14 ports is provided with a sensor port 21. The sensor ports 21 preferably comprise threaded apertures in the housing 2 into which a sensor 21a may be inserted and to which a sensor 21a may be secured. The sensor ports 21 may be staggered in a similar manner to the inlets 19 and outlets 14.

Provided in the rotatable member 6 are a plurality of bores (or metering chambers) 16. Each of the bores 16 passes through the entire cross-section of the rotatable member 6, substantially perpendicular to, and passing through, the longitudinal axis thereof.

The bores 16 are preferably evenly spaced along the length of the rotatable member 6 (that is entirely within the housing 2)—in other words, the bores 16 preferably have an equal spacing along the length of the rotatable member 6. In an embodiment, at least some of the bores 16 are rotationally offset from each other. In other embodiments, the bores 16 are rotationally aligned with each other. The rotational spacing may be even—in other words, the bores 16 may be rotationally offset from each other with an equal rotational spacing between each bore and the bore or bores adjacent to that bore. In an embodiment with three bores 16, an end of each bore 16 may be rotationally offset by 60° with respect to adjacent ends of the other two bores 16.

Received within each bore 16 is a shuttle element 17 (or metering shuttle), which acts to separate sealingly two ends of the bore 16 so that liquid may not directly pass through the bore 16 past the shuttle element 17. The shuttle element 17 is, however, movable within the bore 16 between two terminal positions, at or near the respective ends of the bore 16. In the embodiment depicted in FIG. 1, a retaining pin 25 is provided which is inserted into a recess in the side surface of the rotatable member 6, and passes through the centre of the bore 16 at right angles to the longitudinal axis thereof. A slot 26 runs along the centre of the shuttle element 17, and receives the retaining pin 25. The shuttle element 17 may then move within the bore 16, with the retaining pin 25 sliding within the slot 26, and with the movement of shuttle element 17 being halted when the retaining pin 25 comes into contact with either end of the slot 26. In other words, the shuttle element 17 moves with respect to the retaining pin 25 and movement of the shuttle element 17 is halted when an end of the slot 26 in the shuttle element 17 contacts the retaining pin 25.

In the depicted example, each shuttle element 17 has two end surfaces which are arcuate (see FIG. 2 for example). The arcuate end surfaces of each shuttle element 17 correspond with the degree of curvature of the internal bore 2a of the housing 2. Thus, each shuttle element 17 does not restrict rotational movement of the rotatable member 6 in the housing 2 (even when at a terminal end of the bore 16). In addition, the volume defined between the end surface of the shuttle element 17 and the internal bore 2a of the housing 2 can be easily calculated (i.e. the volume is effectively a cylinder). Other shapes of shuttle element are possible, however.

Additionally, or alternatively, the ends of the bore 16 may each comprise a relatively narrow portion forming a seat (not shown), which physically halts the movement of the shuttle element 17 at one of its terminal positions.

Each sensor 21a comprises a proximity sensor which is configured to sense the position of the shuttle element 17 within its bore 16. The sensors 21a are located in respective sensor ports 21 which are oriented and positioned such that the sensors 21a can sense when a shuttle element has reached a terminal end of its respective bore 16. In an embodiment, more than one sensor 21a is used for each shuttle element 17. In an embodiment, one sensor 21a can sense the position of more than one shuttle element 17 in their respective bores 16.

In an embodiment, each sensor 21a comprises an inductive sensor which is configured to output a signal if a metal object is located within a predetermined distance of the sensor 21a. The sensor 21a is located such that the bore 16 will rotate past the outlet 14 before it rotates past the sensor 21a. Under normal operation, the shuttle element 17 will be located at the terminal end of the bore which is nearest the outlet 14 as the bore 16 passes the sensor 21a. Therefore, if the device 1 is operating correctly, a substantially continuous signal will be output by the sensor 21a (as a metal object will always be within the predetermined distance of the sensor 21a). If the shuttle element 17 fails to reach the terminal end of the bore 16, then this will be sensed by the sensor 21a.

In embodiments of the invention different types of sensor 21a may be used. These include electrically operated contact sensors and sonic sensors. It will be appreciated that the use of certain types of sensor will require the sensor 21a to be located in a sensor port 21 which is not as described above. For example, a contact sensor (which detects contact between the sensor and the shuttle element 17) may be partially located in an outlet 14 of the device 1.

In operation of the metering device 1, ingress 20 valves are fitted to the inlets 19 and outlet pipes 15 are fitted to outlets 14 (through the use of the threads 19a, 14a of the inlets 19 and outlets 14)—see FIGS. 2 and 4. The inlets 19 may be connected to a supply of liquid 23. In an embodiment, valves 20 need not be used. The or each liquid is preferably a fully compressed, hydraulic liquid, as this will allow the greatest accuracy in metering.

The rotatable member 6 is caused to rotate about its longitudinal axis and liquid to be dispensed is fed into a first ingress valve 20a under pressure (see FIG. 4).

A first bore 16, which is rotating as part of the rotatable member 6, is oriented so that a first end thereof is in liquid communication with the first ingress valve 20a. Liquid flows through the first ingress valve 20a into the first bore 16 and a first shuttle element 17 within the first bore 16 is driven to a first of the two terminal positions thereof (where its movement is halted by the retaining pin 25 reaching an end of the slot 26—as described above). The first bore 16 is now loaded.

The rotatable member 6 is caused to rotate further such that a second bore 16 (which is offset with respect the first bore 16—see above) is oriented so that a first end thereof is in liquid communication with a second ingress valve 20b. Liquid to be dispensed has been fed into the second ingress valve 20b under pressure and this liquid flows through the second ingress valve 20b into the second bore 16. A second shuttle element 17 within the second bore 16 is driven to a first of the two terminal positions thereof (where its movement is halted by the retaining pin 25 reaching an end of the slot 26—as described above). The second bore 16 is now loaded.

In the three bore system shown in some of the figures, the rotatable member 6 is caused to rotate further and a third bore 16 is loaded, through a third ingress valve 20c, in the same manner as the first 16 and second 16 bores (see FIG. 4 in which like reference numerals have been used for like parts associated with the three bores 16).

The rotatable member is caused to rotate further such that the first bore 16 is oriented so the first end thereof is in liquid communication with a first outlet 14, the second end of the first bore 16 (which opposes the first end) is in liquid communication with the first ingress valve 20a (the first ingress valve 20a and first outlet 14 opposing each other across a diameter of the housing 2—as discussed above). Liquid to be dispensed is fed through the first ingress valve 20a into the second end of the first bore 16. This causes the first shuttle element 17 to move towards a second of the two terminal positions thereof (until its movement is halted by the retaining pin 25 reaching an end of the slot 26—as described above). The liquid which was already in the first bore 16 is driven from the first bore 16 through the first outlet 14, and out of a first egress valve 15a as liquid is loaded into the first bore 16 through the second end of the bore 16 and the first ingress 20a valve. Thus, a single shot of predetermined volume is dispensed from the first bore 16 as a further shot is loaded.

In a similar manner, the respective shuttle members 17 of the second and third bores 16 are actuated to dispense the liquid held therein through respective second and third egress valves 15b, 15c, and to re-load the bores 16 with liquid (from the opposing end of the bore 16 from which liquid is dispensed).

In an embodiment, each shot of liquid is precisely measured and multiple cycles of rotation of the rotatable member 6 can be used to dispense a substantially continuous stream of shots of liquid from the outlets 14 of the device 1. It will be appreciated that, in this embodiment, the rotatable member 6 can be driven to rotate at a relatively high rate, with a large throughput of liquid, while still maintaining a very high precision in the quantity of liquid dispensed.

In an embodiment, the rotational spacing of the bores 16 is such that, following the dispensing of a shot of liquid from the first bore 16, there is a short period of time before the dispensing of the next shot of liquid from the second bore 16 occurs. This means that there is a “full stop” position, in which none of the bores 16 is aligned with an outlet 14. Thus, if very precise dispensing of liquid is required, the rotatable member 6 can be driven to rotate by relatively small increments, in each of which only one bore 16 (or in other embodiments, a predetermined number of two or more bores 16) comes into alignment with its respective outlet 14, and hence only one shot of liquid is dispensed. Each incremental rotation of the rotatable member 6 will therefore lead to the dispensing of one shot of liquid. It will be appreciated this feature can allow the metering device 1 to dispense liquid in a very precisely controlled manner.

It will also be appreciated that the rotational spacing of the bores 16 allows liquid to be dispensed at a relatively constant rate. It will be appreciated that, if a long rotatable member 6 is provided, a large number of bores 16 can be formed through the rotatable member 6, allowing a large throughput of liquid. If all of these bores 16 are rotationally aligned with one another, there will be a large quantity of liquid dispensed as all of the bores 16 align with the outlet ports at the same moment. Forming the bores 16 so that they are rotationally spaced with respect to one another, thus shots of liquid to be dispensed from the bores in a staggered manner through one complete revolution of the rotatable member 6.

It will be appreciated that the number of bores 16 that are provided in the rotatable member 6, and their rotational spacing from one another, can be varied to exert a great degree of control over the throughput of the metering device 1. It will be appreciated that this confers great advantages when compared to the reciprocating dispensing device described above. In such a device, each reciprocation dispenses only one shot of liquid, and involves a large quantity of wasted energy. By contrast, the rotational driving of the rotatable member 6 consumes a relatively small quantity of energy, and can dispense a larger number of shots of liquid in a given length of time.

The inlets 19 and outlets 14 may be arranged around the housing 2 such that the forces applied by the pressurised liquid to the rotatable member 6 through the inlets 19 are partially or substantially cancelled. For example, in a device 1 with three bores 16, two inlets 19 may be provided on one side of the housing 2 with one outlet 14; on the opposing side of the housing 2 (across a diameter thereof) are the two outlets 14 (corresponding with the two inlets 19 on the opposing side) and one inlet 19 (corresponding with the one outlet 14 on the opposing side). This aspect of an embodiment of the invention can help to prevent the rotatable member 6 moving significantly out of substantial coaxial alignment with the housing 2 or bowing under exposure to the pressurised liquid. In another example of an embodiment in which these forces are at least partially cancelled, the inlets 19 and outlets 14 are staggered around the housing 2 (as described above) and the bores 16 are aligned with a longitudinal axis of the rotatable member 6 such that the forces imparted on the rotatable member 6 by the pressurised liquid are at least partially cancelled by each other.

In order to ensure that the metering device is functioning correctly, in preferred embodiments of the invention, a checking and control system 27 is provided to ensure that, when each bore 16 is aligned with a respective inlet 14 and outlet 19, a shot of liquid is properly dispensed (see FIG. 4).

The checking and control system 27 may include a plurality of sensors 21a (as described above) which are coupled to a control system 27. Each sensor 21a issues a signal when the detected position of the shuttle element 17 in the bore 16 which the sensor 21a is monitoring reaches a terminal position (of which each shuttle element 17 will have two—as described above).

As will be appreciated, during operation, the checking and control system 27 may expect to receive a signal from each sensor 21a every time a bore 16 is loaded (and unloaded). If the system 27 fails to receive such a signal when one is expected then an error has occurred and the system 27 will trigger an error operation.

In an embodiment, the checking and control system 27 receives a constant signal from each sensor 21a (indicating that either the rotatable member 6 or shuttle element 17 is always in close proximity to the sensor 21a). If an error in loading a shot of liquid into a bore 16 occurs then this continuous signal will be broken and the system 27 will trigger an error operation.

An error operation may comprise shutting down the device 1 and/or flagging an error to a user on a display screen 27a.

Other inputs into the checking and control system 27 may include an input from a rotational position sensor which is configured to sense the orientation of the drive shaft 11 of the device 1. The rotational position sensor may comprise an optical encoder wheel (not shown). The optical encoder wheel may be encoded with a code which permits the precise rotational orientation of the wheel (and hence the drive shaft 11) to be determined or may comprise a wheel which is encoded with a code which permits the speed of rotation to be determined (and not the absolute rotational position/orientation of the wheel).

The checking and control system (or unit) 27 may include elements which monitor and control the speed of rotation of one or more drive shafts 11 of the or each device 1 associated with the system 27 (the system 27 may monitor and control a plurality of difference devices 1). The system 27 may also monitor and control the pressure at which liquid is supplied to the or each device 1. The system 17 may include a control panel (not shown).

It will be appreciated that the arrangement described above provides an improved metering device, which is able to dispense accurately-measured quantities of liquid, while maintaining a high throughput. Metering devices embodying the present invention may also be provided on different scales, from very small devices to extremely large devices, without the need for significant modification of the device.

Each bore 16 of the plurality of bores 16 of the device 1 may be for dispensing a different liquid or all of the bores 16 in a single device 1 may be for dispensing a single liquid or type of liquid.

In an embodiment, at least one of the inlets 19 is linked to chamber 23 (see FIG. 2) which is filled with pressurised liquid to be dispensed. This chamber 23 acts as a local reservoir for the device 1 (a plurality of inlets 19 may be linked to the same chamber 23). The chamber 23 may be in liquid communication with the bore 16 (or bores 16) for a larger portion of the rotational movement of the rotatable member 6 than would otherwise be the case. This assists the correct operation of the device 1 as less time is required to ensure sufficient pressure has built-up to move the shuttle element 17. Liquid is preferably fed into the inlet 19 or chamber 23 at twice the output rate from the device 1.

The chamber 23 is preferably contained within the housing 2.

In an embodiment, the outlets 14 are linked to an output chamber (not show) which collects the outputs of a plurality of outlets 14.

In embodiments, several devices as described above may be configured to be driven substantially simultaneously. For instance, the rotatable members of each device may comprise part of a longer shaft, which is driven by one or more motors. Alternatively, different motors can be provided to drive respective devices, with the operation of the motors being synchronised, for instance by a processor. In these embodiments, the devices may be driven at different rates, which may be useful if different liquids need to be dispensed simultaneously at different rates.

Further embodiments of the present invention will now be described.

Turning to FIG. 6, an exploded view of components of a modular rotary metering unit 28 is shown. The components include a housing 29, which generally takes the shape of a hollow, elongate cylinder, with an interface surface 30 thereof being flattened and having an outlet 31 formed therein. An inlet (not shown) is formed on the opposite side of the housing 29 from the outlet 31.

An outlet manifold 32 takes the form of an elongate, generally oblong body with openings 33 formed at either end thereof, and a continuous chamber being formed between openings 33. An inlet port (not shown) is formed on an attachment side of the body, and is in liquid communication with the chamber. The outlet manifold 32 is configured so that the attachment side may be fixed to the interface surface 30 of the housing 29, so that the outlet 31 of the housing 29 is in communication with the inlet of the outlet manifold 32. An O-ring 34, or another appropriate type of seal, may be used to prevent leakage at the join between the housing 29 and the outlet manifold 32.

A rotary member 35 is provided to fit closely within the interior of the housing 29. As described above in relation to other embodiments of the invention, the rotary member 35 has a bore 36 formed therethrough, substantially at right angles to the longitudinal axis of the rotary member 35, and a shuttle member 37 is located within the bore 36. The shuttle member 37 is, as will be understood, able to slide back and forth within the bore 36.

Protruding from a first end of the rotary member 35 is a first connector 38, which takes the general form of a cylinder with a transverse groove 39 formed at its distal end. At a second end of the rotary member 35 a second connector 40 is provided, taking the general form of a cylinder with a protruding transverse ridge 41 formed at its distal end. The ridge 41 is formed to be of an appropriate size to fit snugly within the groove 39 formed in the first connector 38.

To assemble the modular unit 28, the rotary member 35 is placed within the housing 29, and the outlet manifold 32 is attached to the housing 29, as discussed above. First and second end caps 42, 43 are then placed over the open ends of the housing 29. Each of the end caps 42, 43 comprises a generally planar plate member 44 having an aperture 45 formed through the centre thereof. The first and second connectors 38, 40 fit snugly and rotatably through the apertures 45, with at least the groove 39 and ridge 41 projecting out beyond the end caps 42, 43. An attachment arrangement, such as a set of threaded bores 57 into which fixing bolts can be inserted, is presented on an external face of each end cap 42, 43.

It will be appreciated that, when assembled in this way, the modular unit 28 forms a generally enclosed unit. Communication with the bore 36 formed in the rotary member 35 is possible through the inlet of the housing 29, or through the apertures 33 in the outlet manifold 32.

An assembled modular unit 28 is shown in FIG. 7.

Turning to FIG. 8, an exploded view is shown of components of a metering device incorporating three modular units 28a, 28b, 28c as described above. A motor 44 is provided at one end of the metering device, and a shaft 45 of the motor includes a groove, into which the ridge 41 of the first connector 40 of the first modular unit 28a can fit. Thus, when the components are assembled, rotation of the drive shaft 45 of the motor 44 will drive rotation of the rotary member 35 of the first modular unit 28a.

A second modular unit 28b is arranged to be substantially coaxial with the first modular unit 28a. When the first and second modular units 28a, 28b are fixed to one another by the attachment arrangements on their respective end caps 42, 43, the ridge 41 of the first connector 40 of the second modular unit 28b will engage with the groove 39 of the first connector 38 of the first modular unit 28a. Thus, the rotary elements 35 of the first and second modular units 28a, 28b will be rotationally engaged.

The next component in the drive chain is a gearbox 46, having a shaft 47 passing therethrough. The shaft is, through a suitable ridge (not shown) which engages with the groove 38 of the first connector 39 of the second modular unit 28b, rotationally linked to the rotary member 35 of the second modular unit 28b.

On the far side of the gearbox 46 is a third modular unit 28c. An end plate 58 is fitted over the free end of the third modular unit 28c, to prevent the protruding ridge 41 of the second connector 40 from accidentally coming into contact with external objects. In a similar manner described to that above, the third modular unit 28c is fixed to the gearbox 46 and the rotary member 35 of the third modular unit 28c is rotationally engaged with the shaft 47 of the gearbox 46. Thus, rotation of the drive shaft 45 of the motor 44 will cause rotation of the rotary members 35 of each of the three modular units 28a, 28b, 28c, as well as the shaft 47 of the gearbox 46.

The gearbox 46 comprises a generally cylindrical housing having a channelling manifold 48 provided on one side thereof. The channelling manifold 48 is of a generally oblong shape, and comprises first and second input ports 49, disposed on first and second opposing sides thereof, and an outlet port 50, which is located on a top surface of the channelling manifold 48.

The positioning of the output manifolds 32, and the channelling manifolds 48, is such that, when the components described above are assembled, the output manifolds 32 of the first and second modular units 28a, 28b align with one another to form a continuous chamber. This chamber is in communication with the second inlet port 49 of the channelling manifold 48. In addition, the output manifold 32 of the third modular unit 28c is aligned with the first input port 49 of the channelling manifold 48. A continuous output channel is therefore defined through the output manifold 32 of each of the modular units 28a, 28b, 28c and the channelling manifold 48 of the gearbox 46. O-rings 53 or similar seals may be placed between the chambers of the manifolds 28a, 28b, 28c, 48.

A first closure cap 51 is attached to the “free” end of the outlet manifold 32 of the third modular unit 28c, and a second closure cap 52 is applied to the “free” end of the output manifold 32 of the first modular unit 28a. These closure caps 51, 52 may be sealed using O-rings 53 or other appropriate seals. It will be appreciated that these closure caps close the output channel that is defined by the manifolds 32,48.

Attached to the upper side of the channelling manifold 48 is a mixer housing 54, which is in liquid communication with the outlet port 50 of the channelling manifold 48. An o-ring 53 or similar seal may be provided where these components are joined to one another. The mixer housing 54 has an outlet 55 which is preferably at its end furthest from the channelling manifold 48. The mixer housing 54 is preferably elongate and hollow.

A mixer blade 56 is disposed within the mixer housing 54. The mixer blade 56 is driven to rotate when the shaft 47 of the gearbox 46 rotates. This may be achieved, for example, by including one or more bevelled gears within the gearbox 46, so as to translate the rotational motion of the shaft 47 into rotational motion of the mixer blade 56, which is preferably oriented substantially at right angles to the shaft 47.

Turning to FIG. 9, the various components of the metering device are shown, with each of the modular units 28a, 28b, 28c being assembled, and the mixer housing 54 being attached to the gearbox 46. These components are shown fully assembled to form a metering device in FIG. 10.

In use of the device it will be understood that liquids will be introduced into the inlet ports of the modular units 28a, 28b, 28c. A different liquid may be introduced into each of the modular units 28a, 28b 28c.

As the drive shaft 45 of the motor 44 is rotated, the rotary members 35 of each of the modular units 28a, 28b, 28c will rotate, thus metering liquid through each of the modular units 28a, 28b, 28c into the respective outlet manifolds 32. Within the outlet channel formed by the outlet manifolds 32 and the channelling manifold 48, the metered liquids will mix, and will be forced into the mixer housing 54. The mixer blade 56 will rotate within the mixer housing 54, thus actively mixing the liquids before they are ejected through the outlet 55 of the mixer housing 54.

It will be appreciated that the use of modular units 28 as described above allows great flexibility in the creation of metering devices. Any appropriate number of modular units 28 can be fixed together, depending on the number and quantity of liquids to be mixed, and these modular units 28 can be fitted together so that a common outlet channel is formed by their outlet manifolds 32.

Alternatively, or in addition, each modular unit can include an inlet manifold, having appropriate ports so that if a plurality of modular units are attached together the inlet manifolds interact to form a common inlet channel. This may be used, for example, if a relatively large quantity of a single liquid is to be metered, in which case the liquid can be introduced into the inlet channel formed by the inlet manifolds, before being metered through each of the modular units.

In embodiments of the invention, two or more motors may be provided, with each motor driving rotation of the rotary members 35 of one or more of the modular units 28. For instance, referring to the arrangement shown in FIGS. 9 and 10, a second motor could be provided directly at the free end of the third modular unit 28c. A spacer unit could be placed between the gearbox 46 and the third modular unit 28c, to maintain the continuity of the outlet channel, but break the rotational engagement between the rotary member 35 of the third modular unit 28c and the shaft 47 of the gearbox 46. It will therefore be understood that rotation of the rotary member 35 of the third modular unit 28c will be independent of the rotation of the shaft 47 of the gearbox 46, and of the rotary members 35 of the first and second modular units 28a, 28b.

This may be desirable if, for instance, it is desired to introduce a greater proportion of a particular liquid, which is metered though the third modular unit 28c. The motor driving the third modular unit 28c can be set to rotate at a higher rate than the motor driving the remaining modular units 28a, 28b, thus allowing metering of a greater quantity of liquid through the third modular unit 28c.

It is also envisaged that, if desired, rotary members having two or more bores passing therethrough may be used in some or all of the modular units 28. If, for example, twice as much of a first liquid as a second liquid is required, the first modular unit 28a may be equipped with a rotary member having two bores formed therethrough, whereas the second modular unit 28b may have a rotary member with a single bore formed therethrough, as described above. As the motor 44 drives rotation of the rotary members of both modular units 28a, 28b at the same rate, it will be appreciated that twice as much of the first liquid as of the second liquid will be metered into the common channel formed by the outlet manifolds 32 of the modular units 28a, 28b.

In certain embodiments the groove 39 and ridge 41 that are formed on the first and second connectors 38, 40 of each modular unit 28 may be arranged so that, if a sequence of modular units 28 is connected together, the bores 36 that pass through the rotary members 35 of the modular units 28 will be rotationally aligned with one another.

In alternative embodiments, the arrangement of the groove 39 and ridge 41 may be configured so that, when two modular units 28 are attached to one another, the bores 36 thereof are rotationally offset with respect to one another. For instance, it could be an offset of 30° between the axis of the groove 39 and the ridge 41 of each modular unit 28. The bore 36 of a second modular unit 28b will therefore be disposed at 30° to the bore 36 of a first modular unit 28a to which it is attached. A third modular unit 28c, which is attached to the second modular unit 28b, will have a bore 36 that is disposed at 30° to that of the second modular unit 28b, and at 60° to that of the first modular unit 28a, and so on. Introducing an offset between the groove 39 and the ridge 41 therefore ensures that any number of modular units 28 may be attached to one another, and the result will be that the bores 36 thereof are staggered with respect to one another, with the attendant benefits which are discussed above.

In further embodiments the angle of one or more of the groove 39 and ridge 41 may be adjusted. For instance, the part of the second connector 40 that carries the ridge 41 may be rotatable with respect to the rest of the rotary member 35, and may be locked in a chosen position to give an offset with respect to the angle of the groove 39. In other embodiments, the engagement elements 38, 39 may be configured so that the metering units 28 can be connected together with the bores 36 of their rotary members 35 in different relative orientations. For instance, the first connector 38 may have a cross- or star-shaped pattern of grooves formed thereon, into which the ridge 41 of the second connector 40 can fit in a variety of orientations. Markings are preferably formed on one or both of the connectors 38, 40 to assist a user in fitting the units 28 together in the desired orientation.

In the above examples, the rotary member comprises a groove 39 and ridge 41 as its cooperating connectors. However, it should be understood that each rotary member 35 can have any type of first and second cooperating connectors at its opposing ends. Examples include friction clutch elements, planar surfaces having mating studs and depressions, respectively, and corresponding axial column and bore, having an appropriate keyway (for example) to prevent relative rotation.

In the above-described embodiment, a dynamic mixer is driven by the same motor that drives rotation of the rotary members of at least some of the modular units. This is advantageous as it ensures that, whenever liquid is being metered through the modular units, the dynamic mixer is in operation.

In certain embodiments, however, a dynamic mixer may be driven by a separate motor. In these embodiments, the dynamic mixer may be configured to be activated whenever the modular units are metering liquid therethrough. In preferred embodiments, the dynamic mixer may remain active for a short time after the modular units have finished dispensing liquid.

Driving the dynamic mixer by a separate motor may be advantageous in cases where much higher rates of rotation are required for components of the dynamic mixer than are required for the metering units. For instance, in examples like these shown in the accompanying figures, rates of rotation of few tens or hundreds of rotations per second will be used for the rotary members for of the modular units. However, rotary speeds of thousands of revolutions per second may be required for a mixing blade of the dynamic mixer. Although a gearing arrangement may be used within a gearbox to allow the mixer blade to rotate at a significantly higher rate than the rotary members of the modular units, use of a separate motor may be preferable.

If a separate motor is used, it is envisaged that a mixer blade of the dynamic mixer may be alternatively rotated in first and second opposite directions, thus increasing the effectiveness of the mixing effect.

In still further embodiments, a static mixer may be employed. Static mixers involve one or more fixed structures past which the liquids flow, causing the liquids to mix together.

In the embodiments described above only one mixer unit is provided as part of the metering device. It is envisaged, however, that metering devices may comprise more than one mixer unit into which metered liquids are delivered. Preferably, the outputs of the mixer units are diverted to a common output and combined.

In the embodiments described above which have a plurality of bores passing through the rotary member, it is mentioned that the liquid inlets that provide liquid to each of the bores may be staggered around the housing to balance, at least partially, the forces acting on the rotary member.

However, in embodiments where a rotary member within a housing only has one bore, it is not possible to stagger the liquid inlets that feed the bores to balance the forces in this way. It has also been found that, if liquid is input to the device at a high rate, and/or the liquid has a high viscosity, the forces arising from the liquid being fed into the housing can drive the rotary member against the inner surface of the far side of the housing, giving rise to a braking effect on the rotary member. This may slow the rate of rotation, lead to increased wear on the components of the device, reduce efficiency, and even bring the rotary member to a complete stop.

In order to address this difficulty, a balancing arrangement may be provided to balance, at least partially, the forces acting on the rotary member. One example of a balancing arrangement is shown in FIG. 11, which shows a schematic view of a rotary metering unit 59. The metering unit 59 has a housing 60 into which a liquid inlet 61 delivers liquid from a feed vessel 62.

Within the housing 60 (not shown in FIG. 11) is a rotary member having a single bore passing therethrough. The path 63 that the ends of the bore describe during rotation of the rotary member is indicated in FIG. 11 by dotted lines 64. The liquid inlet 61 is arranged to be within the path 63 so that, as the rotary member rotates, the inlet 61 periodically aligns with the bore. A liquid outlet 65 is provided on the opposite side of the housing 60 from the liquid inlet 61.

A balancing inlet 66 is also provided on the opposite, or substantially the opposite, side of the housing 60 from the liquid inlet 61. The balancing inlet 66 is connected, via a balancing liquid feed 67, to the same source of pressurised liquid as the feed vessel 62. Pressurised liquid in the balancing liquid feed 67 therefore acts against one side of the rotary member. Since the balancing inlet 66 is distanced from the path 63 taken by the ends of the bore when the rotary member rotates, however, the liquid in the balancing liquid feed will not enter the bore, and will not be metered by the metering unit 59.

It will therefore be understood that, when pressurised liquid is delivered to the liquid inlet 61, the forces acting on the rotary member will be at least partially balanced, since liquid under the same pressure will act on the rotary member from opposite sides. This system will also be “self correcting” in that, if the pressure of liquid delivered to the liquid inlet 61 changes, the pressure of liquid at the balancing liquid inlet will change correspondingly.

Alternative balancing arrangements may be used. For instance, a balancing element such as a ball or roller may be provided (preferably within the housing), that is biased against the rotary member by a motor, solenoid, or other suitable biasing mechanism. The strength with which the ball or roller is biased against the rotary member may be varied in dependence upon the pressure of liquid that is delivered to the metering unit. In embodiments, a pressure sensor may be provided to measure the pressure of liquid that is being delivered, and the measured pressure may be used to control the force with which the ball or roller is biased against the rotary member. More than one ball or roller may be employed, if necessary.

Balancing arrangements of this type may be used with metering devices or units that have only one bore passing through the rotary member, but may equally be used in embodiments where multiple bores pass through the same rotary member.

In further embodiments, a bearing arrangement may be provided instead of, or as well as, a balancing arrangement. In these embodiments, a bearing arrangement, such as one or more ball bearings, rollers or regions of low-friction material (e.g. bronze), may be mounted against, or in close proximity to, the rotary member. For instance, the bearing arrangement may be located substantially opposite a liquid inlet, but spaced apart from the path taken by the ends of the bore that is fed by the liquid inlet. If forces arising from the input of pressurised liquid at the liquid inlet act to distort the rotary member, and/or to force the rotary member against the interior of the housing, the shaft will bear against the bearing arrangement, and will therefore be able to continue rotating freely.

The bearing arrangement need not be directly opposite the liquid inlet, and may be located elsewhere around the rotary member. However, it is important that the rotary member will bear against the bearing arrangement if it is deflected or distorted by the pressure of liquid being introduced into the liquid inlet. For instance, ball bearings, rollers or regions of low-friction material may be located above and below the position which is directly opposite the liquid inlet, so that the rotary member will bear against both when highly pressurised liquid is fed into the inlet.

Preferably the bearing arrangement is close, in the direction to the longitudinal axis of the rotary member, to the position of the liquid inlet. The bearing arrangement is also preferably spaced apart from the ends of the widest part of the rotary member, i.e. the part through which the bore(s) are formed, rather than on narrowed portions of the rotary member that are provided at either end.

Once again, bearing arrangements of this type may be used with metering devices or units that have only one bore passing through the rotary member, but may equally be used in embodiments where multiple bores pass through the same rotary member.

It will be appreciated that the present invention provides practical, flexible metering devices which will find application in many fields. It is envisaged that metering devices embodying the present invention may be able to deal with wide ranges of liquid throughput rates, varying from around 0.05 mls/min to 200 l/min or more. It is expected that fluids having viscosities ranging from 10 cp to 1 million cp or more may also be metered, as well as heavily filled fluids. It is also envisaged that embodiments of the invention will be able to output metered liquids in a smooth and regular manner, when compared to known metering devices.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A modular rotary metering unit comprising:
a housing having at least one liquid inlet and liquid outlet;
a rotatable member arranged to rotate about a longitudinal axis thereof with respect to the housing; and
at least one bore passing through the rotatable member, the or each at least one bore having two opposing ends and a shuttle element received therein, the shuttle element being movable between two terminal positions, each towards a respective end of the bore, wherein, when the rotatable member rotates, each bore moves in communication with a liquid inlet of the housing and a liquid outlet of the housing such that liquid can be received from the liquid inlet by the bore at the one end of the bore and the shuttle element can eject liquid from the other end of the bore to the liquid outlet,
wherein respective first and second engagement elements are provided at each of said two opposing ends of the unit, respectively, each of the engagement elements being rotationally linked to the rotatable member.

2. A modular rotary metering unit according to claim 1 wherein the rotatable member comprises a shaft, and the first and second engagement elements comprise respective ends of the shaft.

3. A modular rotary metering unit according to claim 1 wherein the modular rotary metering unit may be aligned with, and connected to, a second modular rotary metering unit, such that one of the engagement elements of the modular rotary metering unit will engage with one of the engagement elements of the second modular rotary metering unit, so that the rotatable members of the modular rotary metering unit and the second modular rotary metering unit are rotatably linked.

4. A modular rotary metering unit according to claim 3 wherein when the modular rotary metering unit and the second modular rotary metering unit are connected to one another, the bores of the modular rotary metering unit and the second modular rotary metering unit are rotationally aligned with one another.

5. A modular rotary metering unit according to claim 3 wherein, when the modular rotary metering unit and the second modular rotary metering unit are connected to one another, the bores of the modular rotary metering unit and the second modular rotary metering unit are rotationally offset with respect to one another.

6. A modular rotary metering unit according to claim 3, wherein at least one of the engagement elements is adjustable so that, wherein when the modular rotary metering unit and the second modular rotary metering unit are connected to one another, the relative orientation of the bores of the modular rotary metering unit and the second modular rotary metering unit may be adjusted.

7. A modular rotary metering unit according to claim 3, wherein at least one of the engagement elements is configured so that the other engagement element of a second modular rotary metering unit may engage said at least one of the engagement elements in a variety of orientations.

8. A modular rotary metering unit according to claim 1 further comprising an outlet manifold into which liquid may pass once it has been ejected from the bore by movement of a shuttle element in said modular rotary metering unit.

9. A modular rotary metering unit according to claim 8 wherein, if the modular rotary metering unit and a second modular rotary metering unit are aligned and attached to one another, the outlets of the modular rotary metering unit and the second modular rotary metering unit define a continuous outlet channel through which liquid may flow.

10. A modular rotary metering unit according to claim 9, wherein the outlet channel is substantially parallel with the longitudinal axis of the rotatable members of the modular rotary metering unit and the second modular rotary metering unit.

11. A modular rotary metering unit according to claim 1, having a plurality of bores passing through the rotatable member.

12. A modular rotary metering unit according to claim 1 connected to a plurality of identical modular rotary metering units.

13. A modular rotary metering unit according to claim 3, further comprising a mixer unit to mix liquids metered by the modular rotary metering units.

14. A modular rotary metering unit according to claim 13, wherein the mixer unit comprises a mixer blade which rotates to mix liquids.

15. A modular rotary metering unit according to claim 13, further comprising at least a second mixer unit.

16. A modular rotary metering unit according to claims 13, wherein the mixer blade is linked to the rotatable member of the modular rotary metering unit, so that the mixer blade rotates whenever the rotatable member rotates.

17. A modular rotary metering unit according to claim 13, wherein the modular rotary metering unit has an outlet which combines with the outlets of other modular rotary metering units to form a continuous outlet channel.

18. A modular rotary metering unit according to claim 17, wherein the mixer unit forms a part of the continuous outlet channel.

19. A rotary metering device comprising:
a housing having at least one liquid inlet and liquid outlet;
a rotatable member arranged to rotate about a longitudinal axis of the housing; and
first and second bores passing through the rotatable member, each bore having a two opposing ends and a shuttle element received therein, the shuttle element being movable between two terminal positions, each towards a respective end of the bore, wherein, when the rotatable member rotates, each bore moves into communication with a liquid inlet of the housing and a liquid outlet of the housing such that liquid can be received from the liquid inlet by the bore at the one end of the bore and the shuttle element can eject liquid from the other end of the bore to the liquid outlet.

20. A rotary metering device according to claim 19, wherein at least some of the bores are offset with respect to one another around the diameter of the rotary metering device.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)
